(19) United States
(12) Patent Application Publication
(10) Pub. No.: US 2012/0145328 A1
(43) Pub. Date: Jun. 14, 2012

(54) TIRE EXTRACTOR APPARATUS

(76) Inventors: George Michael Stoila, Tallmadge, OH (US); Dale Eugene Wells, Massillon, OH (US); Thomas Alan Sells, Topeka, KS (US)

(21) Appl. No.: 12/965,044

(22) Filed: Dec. 10, 2010

(51) Int. Cl. B29D 30/06

(52) U.S. Cl. 156/394.1

(57) ABSTRACT

A tire support device is disclosed having an annular support member having an inner surface and an outer surface. A support flange is mounted to the annular support member, the support flange has an inflatable bladder mounted into its inside surface. The inflatable bladder has an inflated position for supporting the tire and an uninflated position for releasing the tire.

### FIELD OF THE INVENTION

The invention relates to the field of manufacturing, and more particularly to tire manufacturing.

### BACKGROUND OF THE INVENTION

In tire manufacturing, after a green tire is made, it is removed from the tire building drum and sent to the tire curing press typically via an automated process such as a conveyor belt. For very large tires such as earth mover tires, the typical automated process will not suffice due to the size and weight of the tire. Very large tires having a diameter over 50 inches need to be moved from the tire building machine to the tire mold and then manipulated into the mold. Thus it is desired to have a tire extraction apparatus to remove the green tire from the tire building drum and being capable of storing the green tire for short period of time without damaging the tire.

### DEFINITIONS

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

### BRIEF DESCRIPTION OF THE DRAWINGS

The invention will be described by way of example and with reference to the accompanying drawings in which:

FIG. 1 is a perspective view of a tire extractor device of the present invention shown with a tire;

FIG. 2 is a perspective view of a tire extractor device of the present invention shown without a tire;

FIG. 3 is front view of the tire extractor device shown together in a support frame device;

FIG. 4 is a is side view of the tire extractor device and the support frame device;

FIG. 5 is a cross-sectional view of the bladder assembly shown in the inflated position in conjunction with a portion of a tire;

FIG. 6 is a cross-sectional view of the bladder assembly shown in the un-inflated position in conjunction with a tire;

FIG. 7 is a cross-sectional view of the bladder in the unassembled position; and

FIG. 8 is a front view of the tire extractor ring with a tire mounted therein and shown in the horizontal position.

### DETAILED DESCRIPTION OF THE INVENTION

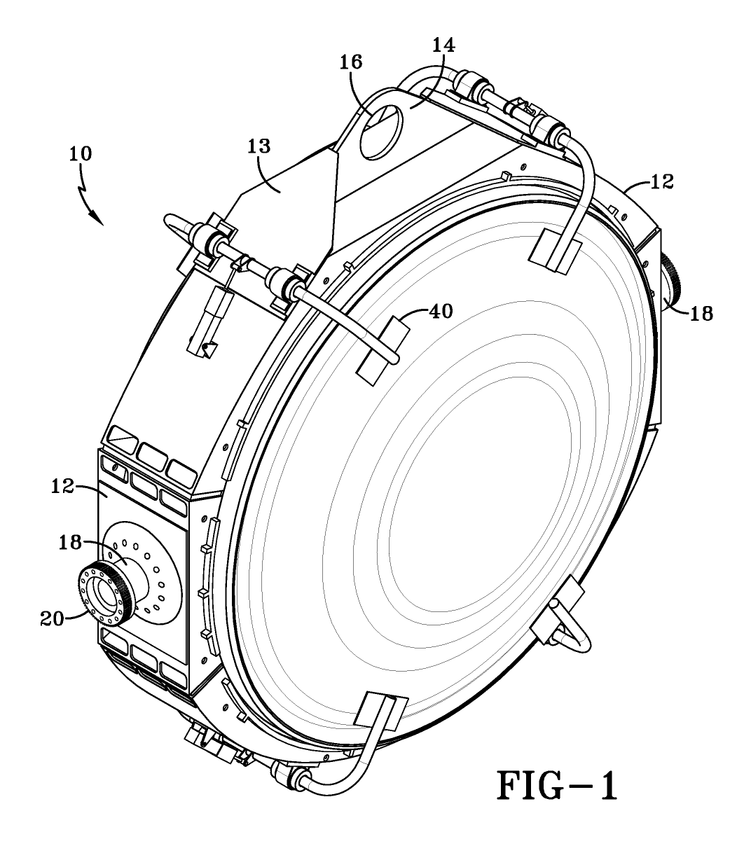

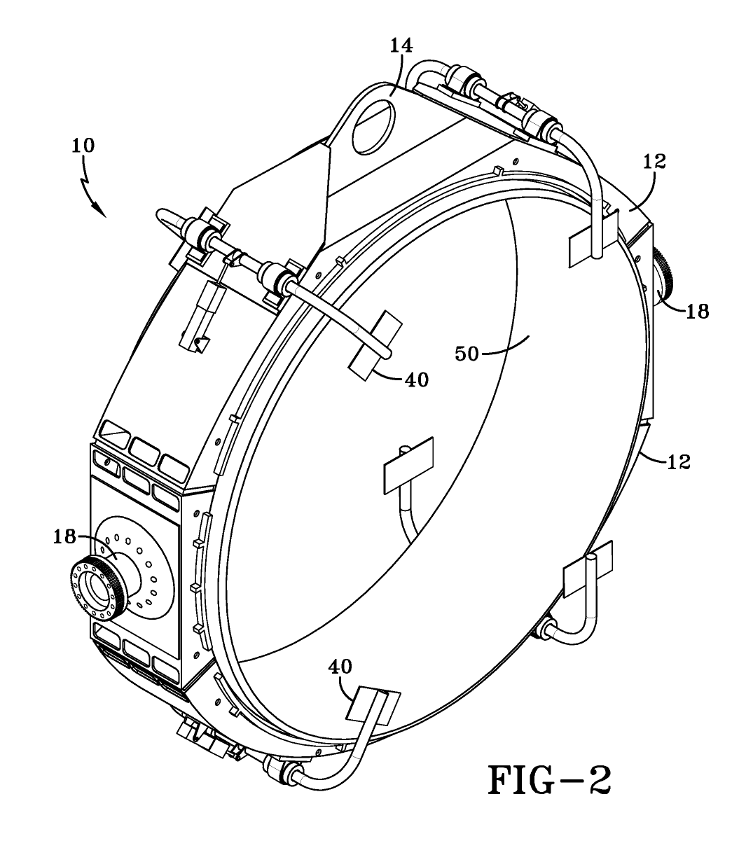

FIGS. 1 and 2 illustrate a tire extraction ring 10 suitable for removing a tire from a tire building drum (not shown). The tire extraction ring 10 is particularly suitable for large heavy tires, particularly tires having a size greater than 50 inches in diameter. The tire ring extractor 10 is formed of one or more arcuate segments 12 which are assembled together to form an annular ring. The segments 12 are preferably formed of steel meeting the standard of a pressure vessel grade weldment. One of the segments 13 has a flanged end 14 with a hole 16 for receiving a hook of a crane. Two of the segments have diametrically opposed support rods or trunnions 18 which are welded to the segments. The support rods have an outer annular surface 20 which has an annular gear. The annular gear can be connected to drive means (not shown) for articulating the angle of the extraction ring from a vertical position to a horizontal position or any angle as desired. The tire extractor ring further comprises a plurality of retention arms 40 which prevent the tire from falling out when the tire extractor ring is rotated horizontally as shown in FIG. 10. The retention arms 40 are pivotally mounted to the exterior of the extractor ring so that they can pivot 180 degrees and out of the way of the tire.

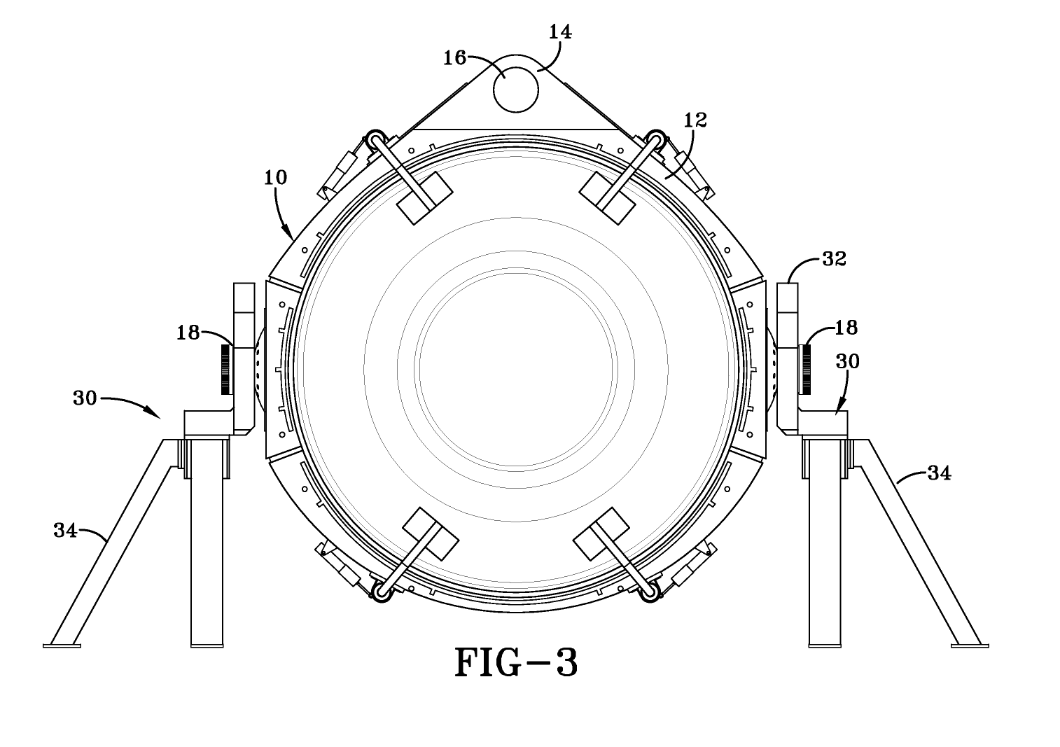

FIGS. 3 and 4 illustrate the tire ring extractor 10 mounted in a first and second tripod support stand 30. The tripod support stand 30 has an upper portion having a J shaped hook 32. The tripod support stands are positioned with respect to a tire extractor ring so that as the tire extractor ring is lowered via a crane, the opposed trunnions are lowered until they are received within the interior portion 31 of the J shaped hooks. The J shaped hooks allow for the rotation of the tire extractor ring. The J shaped hooks are supported by three support legs 34.

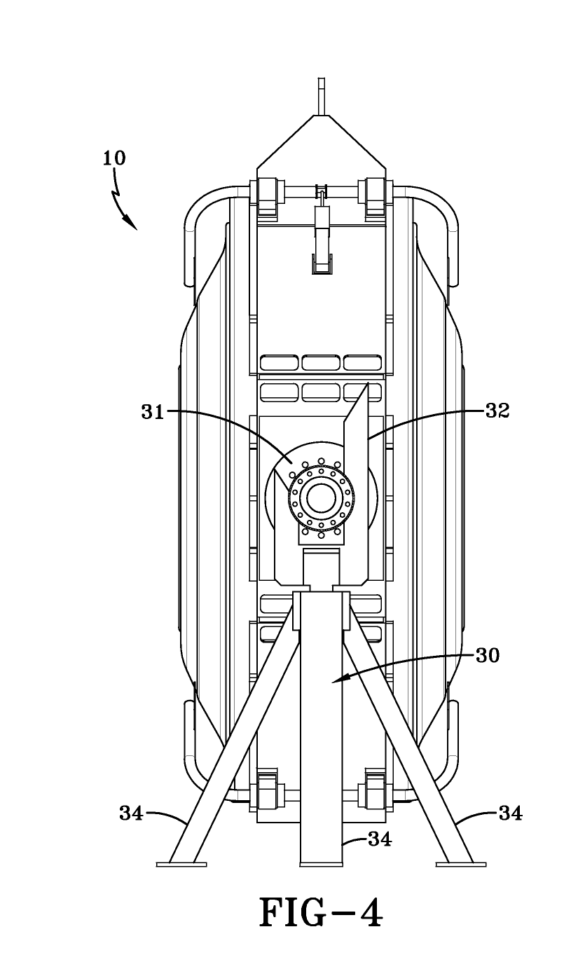

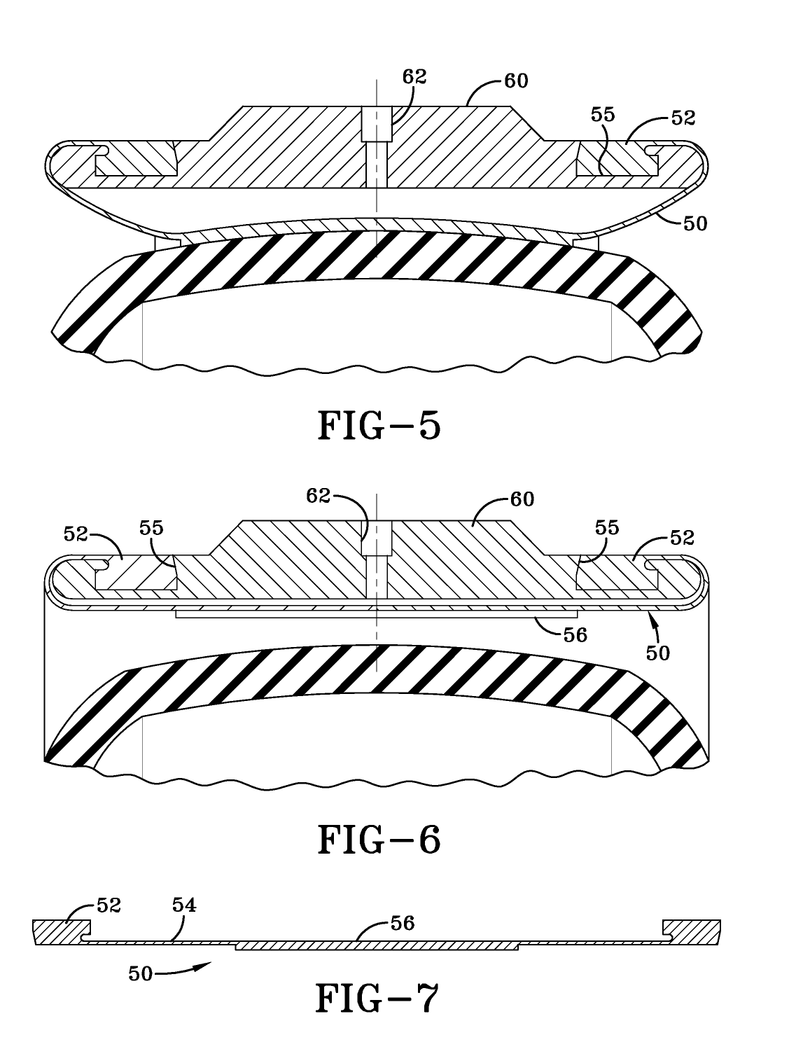

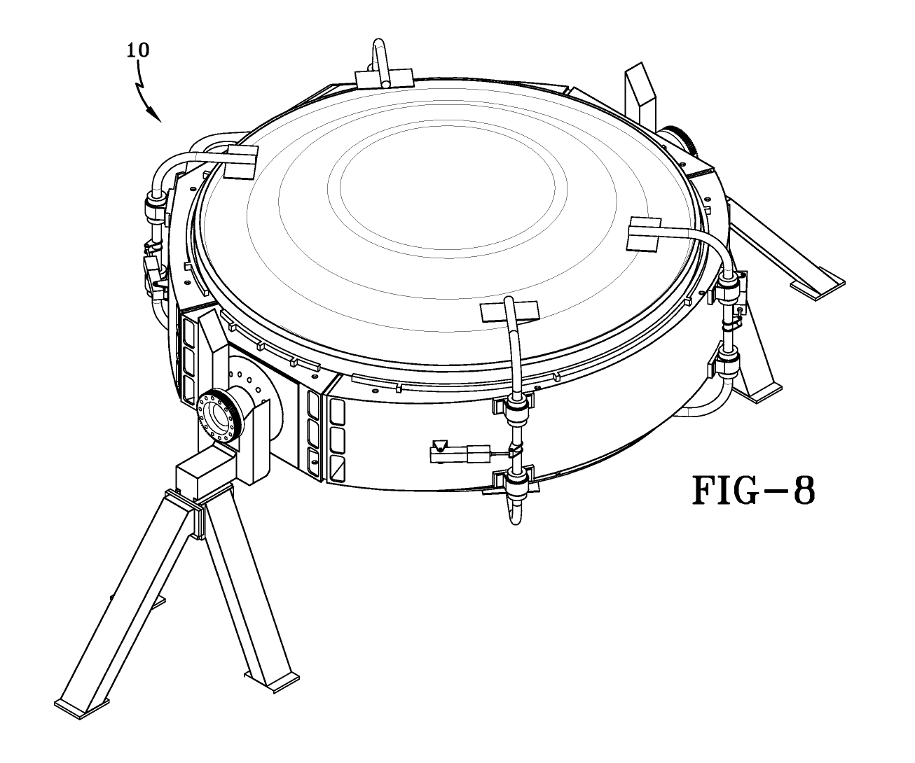

As shown in FIG. 2, the tire extractor ring further comprises a bladder 50 located on the internal surface of the tire extractor ring 10. The bladder functions as a clamp to retain the tire in place when in the inflated position. The bladder 50 is shown unassembled in FIG. 7. The bladder 50 is formed from an annular flexible sleeve preferably made of rubber or elastomer. The bladder material may preferably comprise textile reinforcements such as nylon or aramid. On the exterior surface 54 of the bladder there is a cord layer 56, preferably formed of high strength reinforcements such as steel. The steel cords are parallel and are oriented at a low angle with respect to the circumferential direction of the annular bladder in its assembled condition. More preferably the angle of the reinforcements are in the range of about 0 degrees to about 90 degrees, and more preferably in the range of about 30 to about 60 degrees as measured relative to the circumferential direction. Preferably, there are two layers of steel cord. The one or more reinforcement layers have a width about ⅔ the width of the bladder. The outer ends of the bladder preferably comprise rubber feet 52 which are received within receptacles 55 in an annular support flange 60. FIGS. 5 and 7 illustrate the bladder in the inflated condition and in engagement with a portion of a tire T, while FIGS. 6 and 8 illustrates the bladder in the uninflated condition. The annular support flange 60 has one or more circumferentially spaced interior passageways 62 for supplying air to the bladder.

During operation, a crane or other lifting device lifts the empty tire extractor ring into close proximity of a tire building drum. The extractor ring is lowered until the center of the extractor ring aligns with the center of the tire built on the tire building drum. The extractor ring is then slid over the outer circumference of the tire. The bladder 50 of the extractor ring is then inflated to fully engage the tire, and the tire building drum is actuated into a smaller diameter position. The tire extractor ring then removes the tire from the tire building drum.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire support device comprising:
a support member having an inner surface and an outer surface;
a support flange mounted to the annular support member, the support flange having an inflatable bladder mounted thereto, said inflatable bladder having an inflated position for supporting said tire and an uninflated position for releasing the tire.

2. The tire support device of claim 1 wherein the support member is annular.

3. The tire support device of claim 1 wherein the support flange is annular.

4. The tire support device of claim 1 wherein the inflatable bladder is annular.

5. The tire support device of claim 1 wherein the support member has opposed trunnions mounted on the outer surface.

6. The tire support device of claim 1 wherein the inflatable bladder has textile reinforcements.

7. The tire support device of claim 6 wherein the reinforcements are angled in range of 0 to 90 degrees with respect to circumferential direction.

8. The tire support device of claim 1 wherein the outer surface of the inflatable bladder has a layer of cord reinforcements.

9. The tire support device of claim 8 wherein the cord reinforcements are steel.

10. The tire support device of claim 1 further comprising a first and second support stand, wherein the tire support device is rotatably mounted within the support stands.

11. The tire support device of claim 3 wherein the annular support flange is mounted to the inner surface of the support member.
